(19) United States
(12) Patent Application Publication
(10) Pub. No.: US 2008/0141967 A1
(43) Pub. Date: Jun. 19, 2008

(54) PLASMA IGNITION DEVICE

(75) Inventors: Yasuhide TANI, Nagoya-city (JP); Hideyuki Katoh, Nishio-city (JP); Tooru Yoshinaga, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/953,257

(22) Filed: Dec. 10, 2007

(30) Foreign Application Priority Data
Dec. 19, 2006 (JP) 2006-340761
Feb. 27, 2007 (JP) 2007-46725

(51) Int. Cl. F02P 23/04

(52) U.S. Cl. 123/143 B

(57) ABSTRACT

A plasma ignition device is provided with a plasma ignition plug having an insulation member to insulate a center electrode from a ground electrode, and electric power supply circuits to apply high voltages to the plasma ignition plug. The plasma ignition device activates the gas in a discharge space of the insulation member into the plasma of a high temperature and a high pressure by the high voltage applied between the center electrode and the ground electrode and injects the same into an internal combustion engine. The electric power supply circuits are connected to the center electrode as an anode and to the ground electrode as a cathode.

### CROSS REFERENCE TO RELATED APPLICATION

This application is based on and incorporates herein by reference Japanese Patent Applications No. 2006-340761 filed on Dec. 19, 2006 and No. 2007-46725 filed on Feb. 27, 2007.

### FIELD OF THE INVENTION

The present invention relates to a plasma ignition device for an internal combustion engine, which is effective to reduce electrode wear of a spark plug.

### BACKGROUND OF THE INVENTION

In a conventional ignition device IL for an internal combustion engine, as shown in FIG. 10A, an ordinary spark plug 10L is used. When an ignition switch 22L is turned on, a low primary voltage is applied from a battery 21L to a primary winding 23L of an ignition coil 23L. When the primary voltage is cut off by the switching of an igniter (transistor) 24L controlled by an electronic control unit (ECU) 25L, a magnetic field in the ignition coil 23L changes, and a high secondary voltage of −10 to −30 kV is generated in a secondary winding 232L of the ignition coil 23L. When the secondary voltage exceeds a withstand voltage of a discharge space (gap) 140L between a center electrode 110L and a ground electrode 131L, discharge DC occurs in the discharge space 140L. As a result, high temperature region HT functioning as an ignition source is formed in a narrow range as shown in FIG. 10B.

In contrast, in a conventional plasma ignition device 1k, as shown in FIG. 9A, when an ignition switch 22k is turned on, a low primary voltage is applied from a discharge battery 21k to a primary winding 231k of an ignition coil 23k. When the primary voltage is cut off by the switching of an igniter (transistor) 24k controlled by an electronic control unit (ECU) 25k, a magnetic field in the ignition coil 23k changes and a high secondary voltage of −10 to −30 kV is generated in a secondary winding 232k of the ignition coil 23k.

Discharge starts when the secondary voltage reaches a discharge voltage proportional to a discharge gap 141k in a discharge space 140k formed between a center electrode 110k and a ground electrode 131k.

At the same time, energy (for example, −450 V, 120 A) stored in a capacitor 33k from a battery 31k for plasma energy supply disposed separately from the discharge battery 21k is discharged in the discharge space 140k at a burst. The gas in the discharge space 140k comes to the state of plasma PLM of a high temperature and a high pressure, and the gas is ejected from an opening 132k formed at the tip of the discharge space 140k. As a result, a very high temperature region ranging from several thousand to several tens of thousand degrees having high directivity and a large capacity is generated.

Consequently, in order to burn a lean air-fuel mixture including less fuel in a direct-injection engine, the application of stratified charge combustion that facilitates the combustion by collecting rich air-fuel mixture gas including rich fuel in the vicinity of the spark plug is expected.

As such a plasma ignition device, U.S. Pat. No. 3,581,141 discloses a surface gap type spark plug. To prevent a center electrode from being contaminated, the plasma ignition device comprises a center electrode, an insulating body having an insertion hole containing the center electrode in the center and vertically extending, and a ground electrode covering the insulating body and having an opening communicating with the insertion hole at the bottom end; and forming a discharge gap in the insertion hole.

In the plasma ignition device 1k, usually a high voltage rectified by rectifiers 26k and 34k is applied so that the center electrode 110k operate as a cathode. As a result, as shown in FIG. 9B, positive ions 50 having a large mass collide with the surface of the center electrode 110k. Cathode sputtering wherein the surface of the center electrode 110k decomposes occurs.

The surface of the center electrode 110k erodes gradually due to the cathode sputtering, the distance between the center electrode 110k and the ground electrode 131k, namely a discharge distance 141k, increases gradually, and discharge voltage increases gradually in proportion to the discharge distance 141k. Consequently, when the plasma ignition device 1k is used for a long period of time, it is likely to fail in discharge before long and cause misfire of an internal combustion engine.

### SUMMARY OF THE INVENTION

It is therefore an object of the present invention to provide a plasma ignition device that suppresses wear of a cathode of a plasma ignition plug caused by cathode sputtering.

According to the present invention, a plasma ignition device comprises a plasma ignition plug, an electric power supply circuit. The plasma ignition plug is provided with a center electrode, a ground electrode and an insulation member to insulate the center electrode from the ground electrode. The electric power supply circuit supplies a high voltage between the center electrode and the ground electrode, so that the plasma ignition plug activates a gas in a discharge space of the insulation member into plasma state of a high temperature and a high pressure by the high voltage. The electric power supply circuit is connected to the center electrode and the ground electrode as an anode and a cathode, respectively.

### BRIEF DESCRIPTION OF THE DRAWINGS

The above and other objects, features and advantages of the present invention will become more apparent from the following detailed description made with reference to the accompanying drawings. In the drawings:

FIG. 1 is a circuit diagram of a plasma ignition device according to a first embodiment of the present invention;

FIG. 2 is a sectional view of an end part of a plasma ignition plug showing plasma generation in the first embodiment of the present invention;

FIG. 3A is a sectional view showing an end part of a plasma ignition plug used in a second embodiment of the present invention;

FIG. 3B is a sectional view of an end part showing plasma generation in the second embodiment;

FIG. 4A is a sectional view showing an end part of a plasma ignition plug used in a third embodiment of the present invention;

FIG. 4B is a sectional view showing an end part of a plasma ignition plug used in a fourth embodiment of the present invention;

FIG. 4C is a sectional view showing an end part of a plasma ignition plug used in a fifth embodiment of the present invention;

FIG. 5A is a sectional view showing an end part of a plasma ignition plug used in a sixth embodiment of the present invention;

FIG. 5B is a graph showing the change in the resistivity of a protection layer provided in the sixth embodiment;

FIG. 6A is a sectional view showing an end part of a plasma ignition plug used in a seventh embodiment;

FIG. 6B is a sectional view showing an end part of a plasma ignition plug used in an eighth embodiment;

FIG. 6C is a sectional view showing an end part of a plasma ignition plug used in a ninth embodiment;

FIG. 6D is a sectional view showing an end part of a plasma ignition plug used in a tenth embodiment;

FIG. 7A is a sectional view showing the end part of the plasma ignition plug used in an eleventh embodiment;

FIG. 7B is a sectional view taken on line 7B-7B in FIG. 7A;

FIG. 8A is another circuit diagram applicable to the first to the tenth embodiments;

FIG. 8B is another circuit diagram applicable to the first to the tenth embodiments;

FIG. 9A is a circuit diagram showing a conventional plasma ignition device;

FIG. 9B is a sectional view of an end part showing generation of plasma in a conventional plasma ignition plug;

FIG. 10A is a circuit diagram showing a conventional spark ignition device; and

FIG. 10B is a schematic view showing discharge in a conventional spark ignition plug.

### DETAILED DESCRIPTION OF THE PREFERRED EMBODIMENTS

### First Embodiment

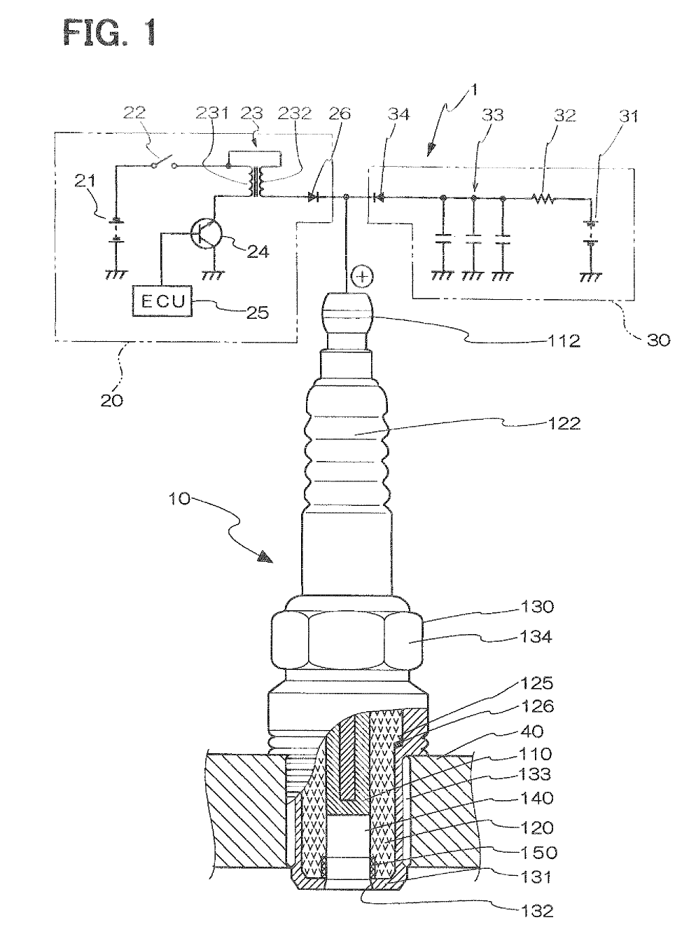

Referring first to FIG. 1, a plasma ignition device 1 is constructed with a plasma ignition plug 10, a discharging electric power supply circuit 20 for discharge, and a plasma generating electric power supply circuit 30 for generating plasma. Both of the electric power supply circuits 20 and 30 are high voltage electric power circuits.

The plasma ignition plug 10 includes a center electrode 110 having the shape of a rod, an electrical insulator 120 as a cylindrical insulation member to insulate and retain the center electrode 110, and a metallic housing 130 having the shape of a cylinder and a closed end to cover the electrical insulator 120.

The tip part (end) of the center electrode 110 is made of an electrically conductive material having a high melting point, a center electrode inner rod made of a metallic material having a high electrical conductivity and a high thermal conductivity, such as a steel material, is formed in the interior, and a center electrode terminal 112 that is exposed from the electrical insulator 120 and is connected to the discharging electric power supply circuit 20 and the plasma generating electric power supply circuit 30 in the exterior is formed at the base end part.

The electrical insulator 120 is made of high purity alumina or the like excellent in thermal resistance, mechanical strength, dielectric strength at a high temperature, thermal conductivity, and others. A cylindrical discharge space 140 extending downward from the tip face of the center electrode 110 is formed at the tip part. A center electrode engaging section 125 to engage with a housing 130 via a packing member 126 to keep airtightness between the electrical insulator 120 and the housing 130 is formed at the middle part. An electrical insulator head section 122 to insulate the center electrode 110 from the housing 130 and prevent a high voltage from escaping to a part other than the electrode is formed at the base end part.

The housing 130 including an annular ground electrode 131 is made of a metallic material having a high melting point and a high thermal conductivity. The annular ground electrode 131 the tip of which bends toward the inside in the radial direction and with which the electrical insulator 120 is covered is formed at the tip of the housing 130. A housing screw section 133 used for fixing the plasma ignition device 1 to an engine block 40 of an internal combustion engine (not shown) so that the ground electrode 131 may be exposed in the internal combustion engine and maintaining the housing 130. Me engine block 40 in an electrically grounded state is formed around the outer circumference at the middle part. A housing hexagonal section 134 used for tightening the screw section 133 is formed around the outer circumference at the base end part.

A ground electrode opening 132 communicating with the inner diameter part of the electrical insulator 120 is formed at the ground electrode 131. Further, the diameter of the ground electrode opening 132 increases toward the tip at a wider angle so as to be larger than the inner diameter of the electrical insulator 120. The tip surface of the center electrode 110 contacting a discharge space 140 does not face the inner surface of the opening periphery of the ground electrode opening 132 contacting the discharge space 140 and both the surfaces are formed so as to be nearly orthogonal to each other.

Furthermore, the annular semiconductor section 150 abutting the ground electrode 131 so as to be conductive with the ground electrode 131 is formed at the tip of the electrical insulator 120. As the semiconductor section 150, semiconductor ceramics comprising tin oxide and hafnium is used for example.

The discharging electric power supply circuit 20 includes a first battery 21, an ignition key 22, an ignition coil 23, an igniter 24 comprising a transistor, and an electronic control unit 25, and is connected to the plasma ignition plug 10 via a rectifier 26.

The first battery 21 is grounded on the side of an anode and rectification is applied with the rectifier 26 so that the center electrode 110 may function as an anode. The plasma generating electric power supply circuit 30 comprises a second battery 31, a resistor 32, and capacitors 33 for plasma generation 33 and is connected to the plasma ignition plug 10 via a rectifier 34.

The second battery 31 is grounded on the side of a cathode and rectification is applied by the rectifier 34 so that the center electrode 110 may function as an anode.

When the ignition switch 22 is turned on, a negative primary voltage of a low voltage is applied to a first winding 231 of the ignition coil 23 from the first battery 21 by an ignition signal from the ECU 25. The primary voltage is cut off by the switching of the igniter 24, a magnetic field in the ignition coil 23 changes and positive secondary voltage of 10 to 30 kV is induced in a secondary winding 232 of the ignition coil 23 by self-induction.

In the meantime, the capacitors 33 for plasma generation are charged with the second battery 31 (for example, 450 V, 120 A).

When the applied secondary voltage exceeds a discharge voltage proportional to a discharge distance 141 between the center electrode 110 and the ground electrode 131, discharge starts between both the electrodes and the gas in the discharge space 140 comes to the state of plasma in a small region.

The gas in the state of plasma has electrical conductivity, causes electrical charge stored between both electrodes of the capacitors 33 to discharge, further induces the state of plasma of the gas in the discharge space 140, and expands the region.

The temperature and the pressure of such a gas in the state of plasma increase and the gas is injected into the combustion chamber of an internal combustion engine.

Here, the discharging electric power supply circuit 20 and the plasma generating electric power supply circuit 30 can be applied also to a second embodiment to an eleventh embodiment, which embodiments are to be described later.

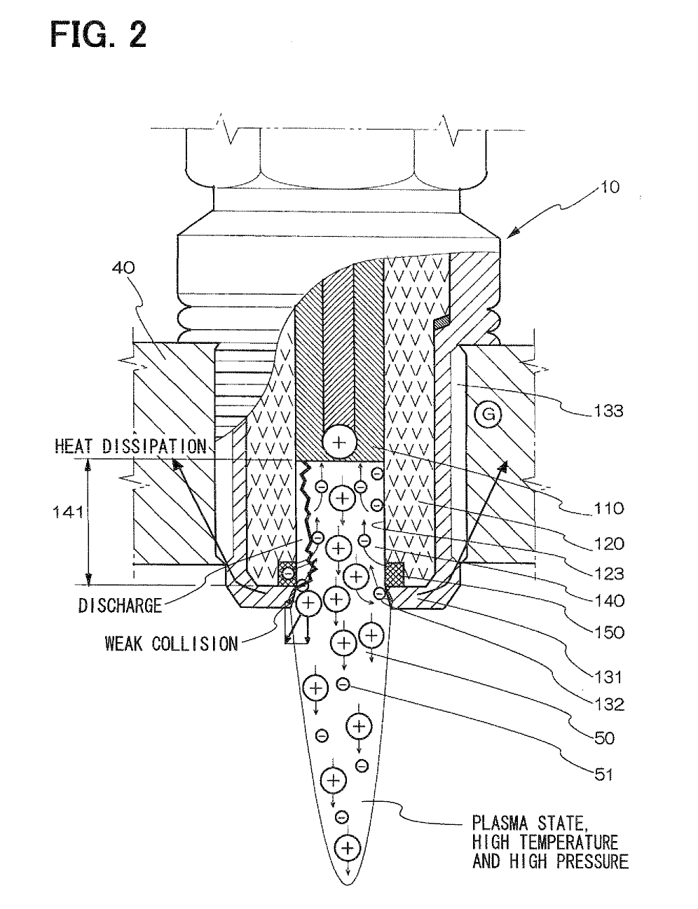

According to the first embodiment, as shown in FIG. 2, since the center electrode 110 is an anode, electrons flow from the ground electrode 131 toward the center electrode 110 by discharge, only the electrons 51 having small masses collide with the center electrode 110, positive ions 50 having large masses, such as nitrogen ions, repel the center electrode 110 as the anode in the gas in the state of plasma, and hence the surface of the center electrode 110 is not eroded by cathode sputtering.

On the other hand, the ground electrode 131 is a cathode and hence the surface thereof may be eroded by positive ions 50 having large masses. However, since the surface of the ground electrode 131 facing the discharge space 140 is placed so as to be nearly orthogonal to the injection direction of the gas in the state of plasma, the positive ions 50 obliquely collide with the surface of the ground electrode 131. Therefore the collision force of the positive ions 50 weakens, the degree of erosion by cathode sputtering comes to be lower than the conventional case where the center electrode is a cathode.

Further, the diameter of the ground electrode opening 132 increases toward the tip (free end or lowermost end in the figure) at a large angle so as to be larger than the inner diameter of the electrical insulator 120 and hence the collision force of the positive ions 50 further weakens. In addition, even though the erosion of the surface of the ground electrode 131 progresses, the change of the discharge distance 141 in the axial direction is small and hence rapid increase of discharge voltage is prevented and misfire is avoided. Furthermore, since the ground electrode 131 is directly screwed to the engine block 40 with the housing screw section 133, the ground electrode 131 is more likely to dissipate heat than the center electrode 110. Consequently, it is possible to suppress the wear of an electrode further than the conventional case where the center electrode 110 is a cathode.

Moreover, by forming the semiconductor section 150 at a part of the surface of the electrical insulator 120, electrons are discharged abundantly from the surface of the semiconductor section 150 since the semiconductor section 150 has many lattice defects and is likely to discharge electrons and the discharge route as an electron flow goes up from the surface of the electrical insulator 120 by the electrostatic repulsion force from the electrons discharged on the surface of the electrical insulator 120.

As a result, even when discharge is repeated, it is possible to prevent the channeling phenomenon wherein metal scattering by cathode sputtering deposits on the surface of the electrical insulator 120 and an electrically conductive route is formed.

### Second Embodiment

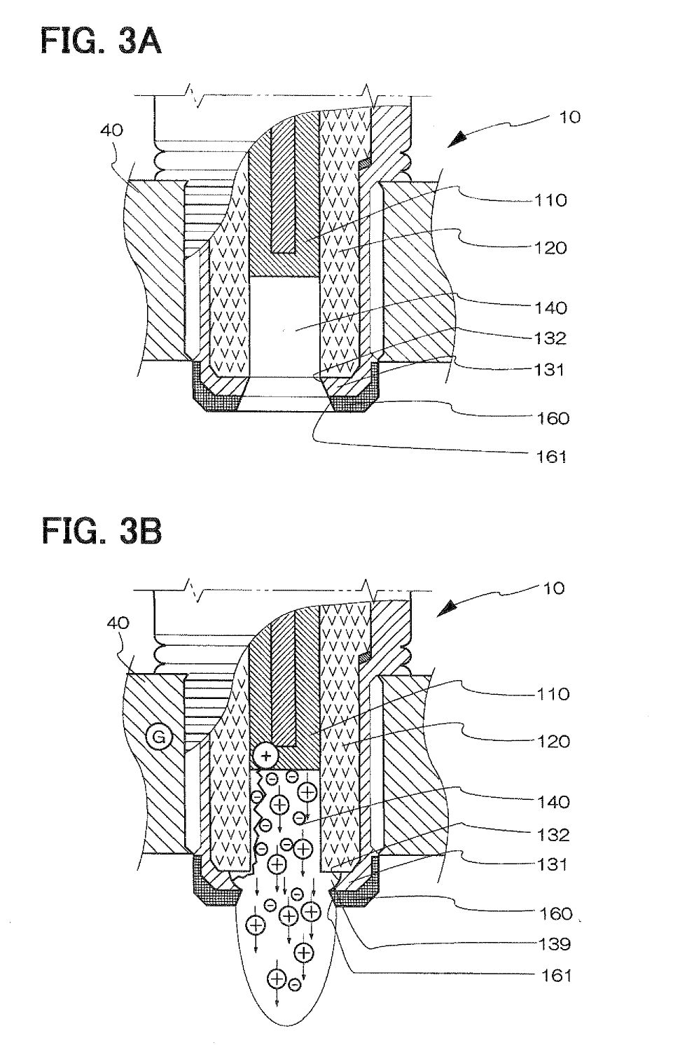

In a second embodiment, as shown in FIG. 3A, a protection layer 160 is formed so as to cover the surface exposed in the engine block 40 other than the surface facing the discharge space 140 of the ground electrode opening 132.

Further, the diameter of the ground electrode opening 132 increases so as to be larger toward the tip and a protection layer opening 161 communicating with the ground electrode opening 132 is formed in the protection layer 160. The protection layer 160a is formed into a nearly annular shape with an insulating material separately from the ground electrode 131 and is joined with the ground electrode 131 by means of screw joining, fitting, or the like.

In the present embodiment, in addition to the advantages similar to those in the first embodiment, even when, by long time use, the erosion of the surface facing the discharge space of the ground electrode opening 132 progresses by the cathode sputtering and an eroded part 139 subsiding toward outside is formed as shown in FIG. 3B, the shape of the opening through which gas in the state of plasma is injected is maintained with the protection layer opening 161.

Further, the protection layer 160 can protect the ground electrode 131 also from heat generated in the engine block 40 during combustion and hence further extension of the service life of the ground electrode 131 can be expected.

### Third Embodiment

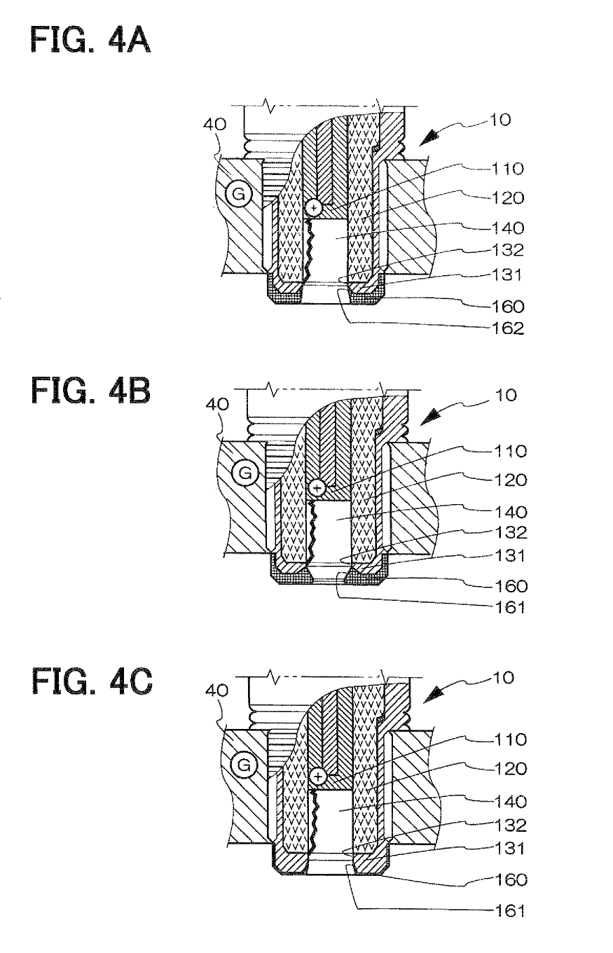

In a third embodiment, as shown in FIG. 4A, the protection layer 160 is formed so that only a part of the side surface of the opening of the ground electrode 131 is exposed to the discharge space 140 as the ground electrode opening 132.

In addition to the advantages of the second embodiment, the electric field strength increases at the discharge portion and discharge is facilitated by reducing the surface area of the ground electrode opening 132. It is thus possible to further reduce the wear speed of the ground electrode 131.

It is generally considered that, when channeling is formed on the inner wall of the electrical insulator 120 forming the discharge space 140, discharge of electrons into the discharge space 140 is hindered. However, it is expected that channeling formed on the bottom face of the electrical insulator 120 has the functions of suppressing the increase of a discharge potential and compensating the wear of the ground electrode 131.

Consequently, since the surface area of the ground electrode opening 132 is narrow, the discharge portion appears in a specific range, and erosion by cathode sputtering concentrates in the narrow range, channeling is likely to occur at the bottom face of the electrical insulator 120, the increase of the discharge potential is suppressed, and the wear of the ground electrode 131 is compensated. It is thus expected that the durability of a plasma ignition device improves further.

### Fourth Embodiment

In a fourth embodiment, as shown in FIG. 4B, the opening 161 of the protection layer 160 is formed into a tapered shape so that the diameter thereof may gradually reduce toward the tip (free end, which is lowermost in the figure). The protection layer 160 is electrically insulative, and is not eroded by cathode sputtering. Hence, it can be formed into the tapered shape so as to protrude toward the inside of the discharge space 140.

Consequently in addition to the advantages in the first, second and third embodiments, even when the erosion of the ground electrode opening 132, on which the protection layer 160 is not formed, of the ground electrode 131 progresses due to long time use, it is possible to smoothen the flow of a gas in the state of plasma when it is injected, enhance the directivity of the injection direction of the gas in the state of plasma, and further improve the stability of a plasma ignition device by the tapered portion 161 formed in the protection layer 160.

### Fifth Embodiment

In a fifth embodiment, as shown in FIG. 4C, the protection layer 160 is a film member formed on the surface of the ground electrode 131 excluding the ground electrode opening 132. As a method for forming the protection layer 160, coating by thermal spraying, CVD, or the like can be adopted, for example.

### Sixth Embodiment

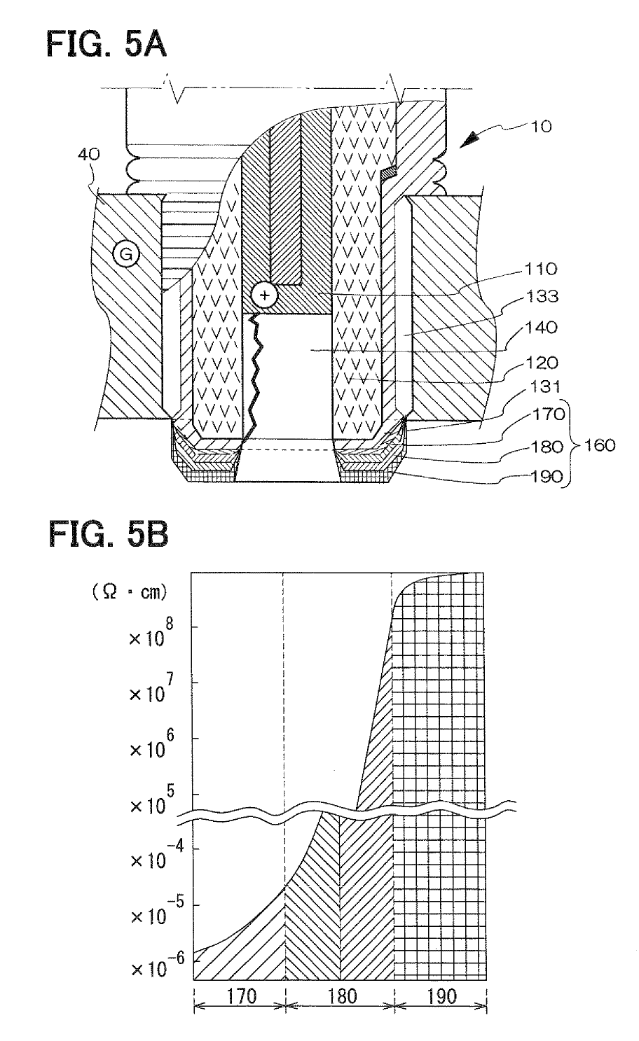

In a sixth embodiment, as shown in FIG. 5A, the protection layer 160 includes materials having different electrical conductivities and is formed into a multilayer. An innermost layer 170 contacting the ground electrode 131 is electrically conductive, an outermost layer 190 facing the discharge space is electrically insulative, and an inclined layer 180 having intermediate characteristics of the innermost layer 170 and the outermost layer 190 is formed between the innermost layer 170 and the outermost layer 190.

As shown in FIG. 5B, an electrically conductive material having a specific resistance (resistivity) of 10⁻⁴ Ω·cm or less is used for the innermost layer 170, an electrically insulative material having a resistivity of 10⁸ Ω·cm or more is used for the outermost layer 190, and a material produced by proportionally blending the electrically conductive material and the electrically insulative material so that the resistivity may gradually increase from the innermost layer 170 toward the outermost layer 190 is used for the inclined layer 180. Thus, the electrical conductivity is decreased gradually from the innermost layer 170 toward the outermost layer 190.

A sintered body integrating the ground electrode 131 and the protection layer 160 can be provided by packing a powdery material in a mold in a vacuum chamber, forming a nearly annular molded body, further pressurizing the molded body and simultaneously applying pulsed voltage to the molded body via the mold, and sintering the molded body by thermal energy generated in the molded body. Then the housing 130 wherein the ground electrode 131 and the protection layer 160 are completely integrated can be provided by joining the sintered body with the tip of the housing screw section 133 by laser welding or the like.

Otherwise, a film member similar to that in the fifth embodiment may be formed by using a plurality of materials having arbitrary resistivities ranging from electrically conductive to electrically insulative and laminating a plurality of films having different electrical conductivities.

### Seventh Embodiment

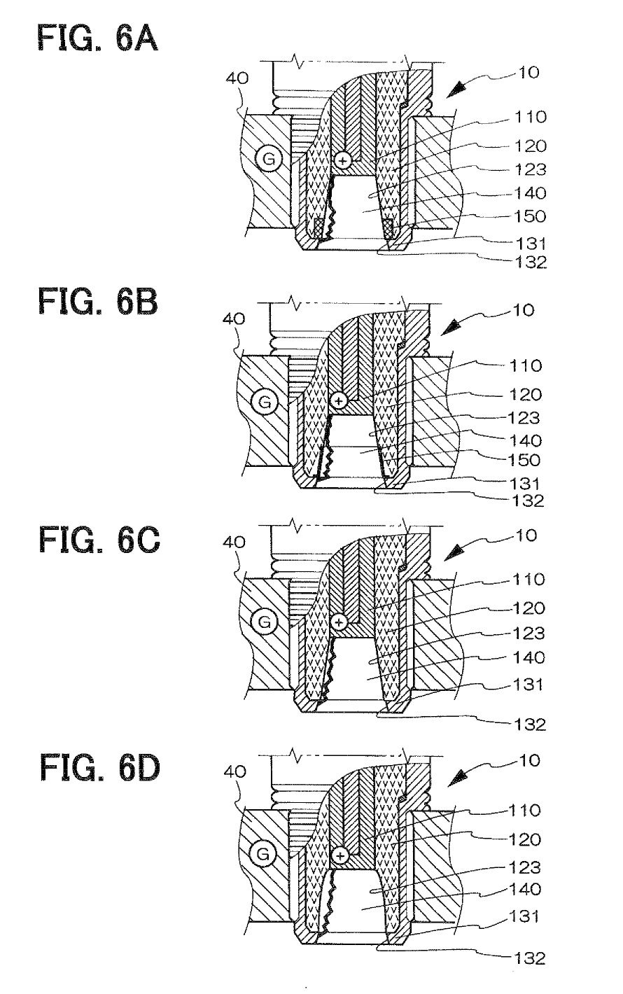

In a seventh embodiment, as shown in FIG. 6A, the ground electrode opening 132 communicating with the inner diameter of the electrical insulator 120 is formed in the ground electrode 131. Moreover the inner diameters of the electrical insulator 120 and the ground electrode opening 132 increase toward the lower side (free end side) of the tip. Further, the diameter of the ground electrode opening 132 increases toward the tip at a wider angle so as to be larger than the inner diameter of the electrical insulator 120.

Consequently, in addition to the advantages in the first embodiment, since the inner diameter of the ground electrode 131 increases toward the tip, the transfer distance of positive ions 50 in the radial direction, namely in the direction orthogonal to the injection direction, up to the positive ions 50 collide with the surface of the opening 132 of the ground electrode 131 increases. Further, the collision force of the positive ions in the state of plasma weakens, and the erosion of the ground electrode by cathode sputtering can be reduced.

This configuration can be adopted also in the first to sixth embodiments.

### Eighth Embodiment

In an eighth embodiment, as shown in FIG. 6B, the semiconductor section 150 includes a film formed on the surface of the electrical insulator 120. The semiconductor section 150 can be easily formed by a method such as vapor deposition, thick film printing, CVD, or the like.

In the present configuration too, the same advantages as the seventh embodiment can be provided.

This configuration can be adopted also in the first to sixth embodiments.

### Ninth Embodiment

In a ninth embodiment, as shown in FIG. 6C, the surface of the ground electrode 131 and the surface of the center electrode 110 are located so as to be nearly orthogonal to each other. The center electrode 110 is an anode, the ground electrode 131 is a cathode. Therefore, positive ions in the state of plasma obliquely collide with the surface of the ground electrode 110. Hence the collision force of the positive ions weakens, and the degree of erosion caused by cathode sputtering lowers in comparison with the conventional case where the center electrode 110 is a cathode.

This configuration can be adopted also in the first to sixth embodiments.

### Tenth Embodiment

In a tenth embodiment, as shown in FIG. 6D, an inner surface 123 of the electrical insulator 120 is formed into a concavely curved surface while the diameter of the inner surface 123 increases toward the tip. This configuration prevents channeling on the electrical insulator surface 123 facing the discharge space 140.

This configuration can be adopted also in the first to sixth embodiments.

### Eleventh Embodiment

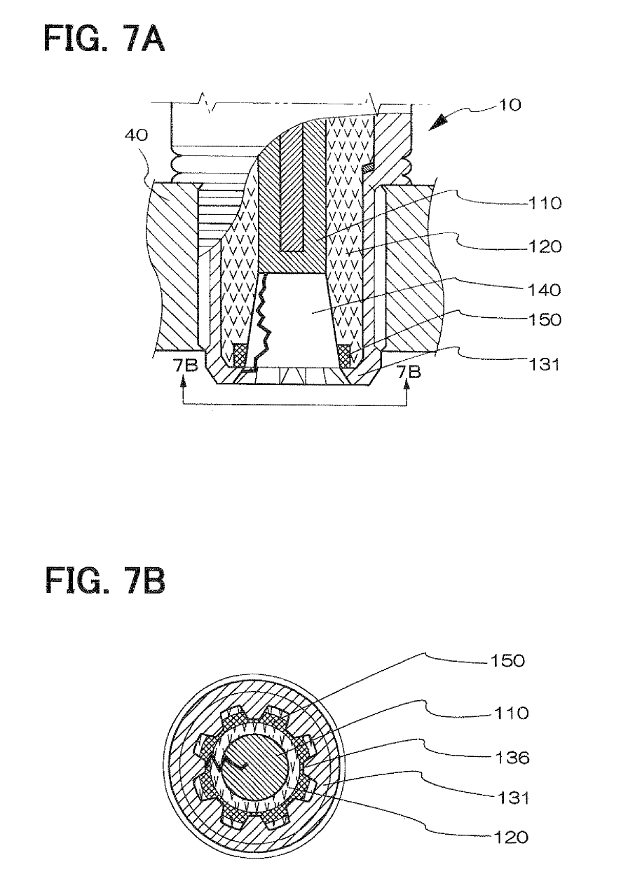

In an eleventh embodiment, as shown in FIG. 7A and FIG. 7B, the ground electrode 131 has a plurality of protrusions 136 protruding toward the center in the radial direction. An electric field strength is collected locally at the protrusions 136, discharge is further facilitated, the collision force of positive ions weakens since the portions other than the protrusions 136 retract outside, and the durability of the ground electrode 131 further improves as a whole.

This configuration can be adopted also in the first to tenth embodiments.

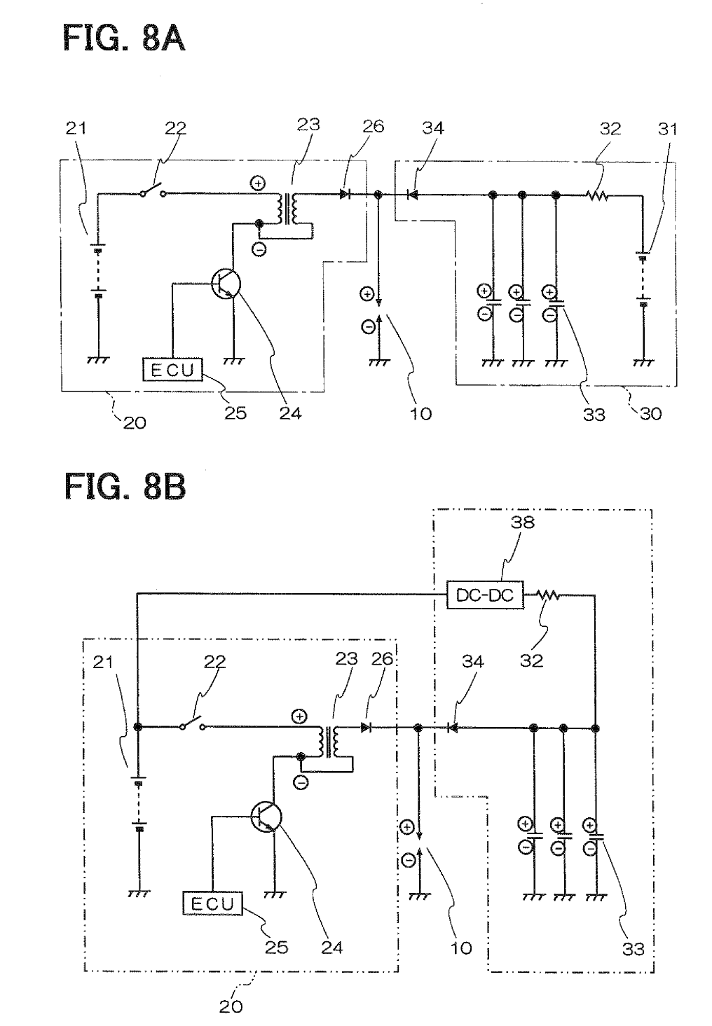

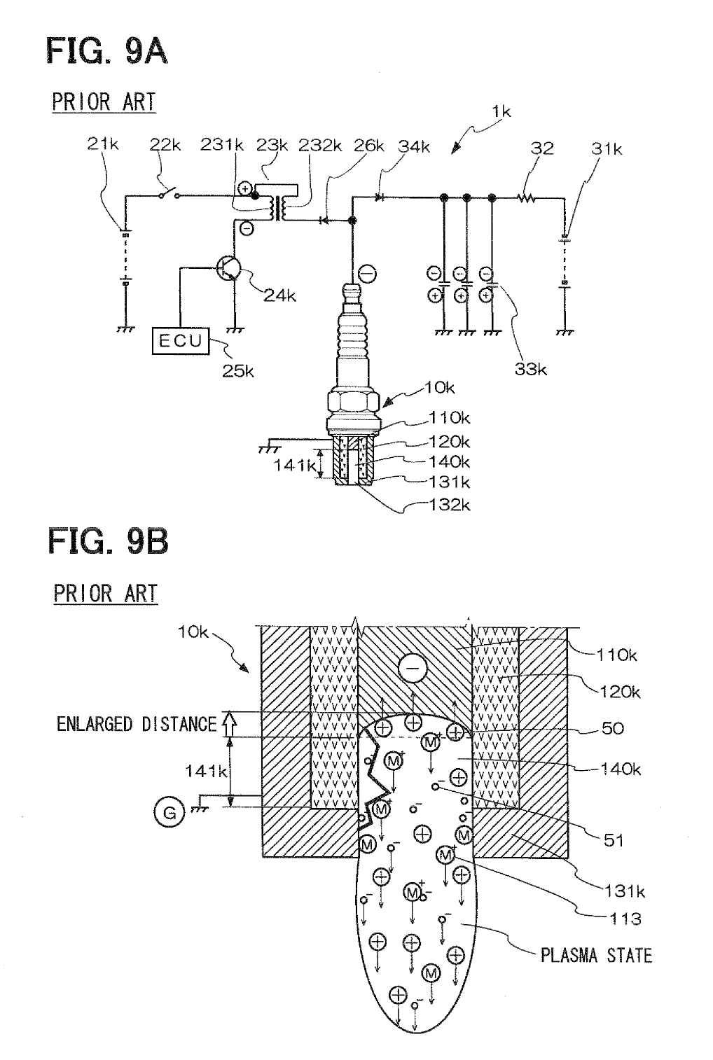

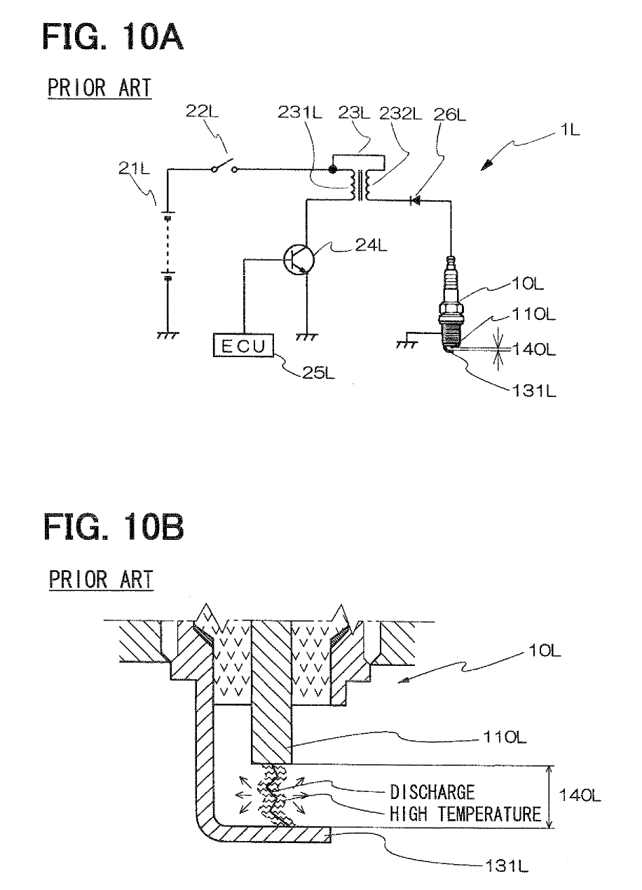

In the first to eleventh embodiments, the power supply circuits 20 and 30 may be modified as shown in FIG. 8A and FIG. 8B.

### (Modifications)

In the case of FIG. 8A, the cathode side of the first battery 21 of the discharging electric power supply circuit 20 is grounded, and the polarities of the ignition coil 23 and the igniter 24 are set in accordance with the polarity of the first battery 21. It is possible to apply a positive high voltage to the plasma ignition plug 10. The advantages similar to the first embodiment can be provided.

Further, in the case of FIG. 8B, the plasma generating electric power supply circuit 30 is connected to the first battery 21 via a DC-DC converter 38 or the like, so that different voltages are produced by the discharge electric power supply circuit 20 and the plasma generating electric power supply circuit 30.

The above embodiments may be applied also to a multiple cylinder engine having a plurality of spark plugs.

What is claimed is:

1. A plasma ignition device comprising:
a plasma ignition plug provided with a center electrode, a ground electrode and an insulation member to insulate the center electrode from the ground electrode; and
an electric power supply circuit for supplying a high voltage between the center electrode and the ground electrode, so that the plasma ignition plug activates a gas in a discharge space of the insulation member into plasma state of a high temperature and a high pressure by the high voltage,
wherein the electric power supply circuit is connected to the center electrode and the ground electrode as an anode and a cathode, respectively.

2. The plasma ignition device according to claim 1, wherein:
the insulation member is formed into a cylindrical shape that covers an outer circumference of the center electrode formed into a shape of a rod and extends more outward than an end face of the center electrode; and
the ground electrode is formed into a cylindrical shape having a bottom end that covers an outer circumference of the insulation member and bent at a tip end toward a center of the discharge space in a radial direction, and having a ground electrode opening communicating with an inner diameter of the insulation member.

3. The plasma ignition device according to claim 1, further comprising:
a protection layer formed to cover a surface of the ground electrode in a state where at least a part of a surface of the ground electrode opening facing the discharge space is exposed toward the discharge space.

4. The plasma ignition device according to claim 3, wherein:
the protection layer is a multilayer that includes materials having different electrical conductivities;
the multilayer includes an innermost layer contacting the surface of the ground electrode and electrically conductive, and an outermost layer facing the discharge space and electrically insulative; and
an electrical conductivity is decreased gradually from the innermost layer toward the outermost layer.

5. The plasma ignition device according to claim 3, wherein the protection layer is a film member formed on the surface of the ground electrode.

6. The plasma ignition device according to claim 4, wherein the protection layer is a molded sintered body, which is made by proportionally blending materials having different electrical conductivities.

7. The plasma ignition device according to claim 3, wherein the protection layer is made of an insulation material and is a member formed separately from the ground electrode.

8. The plasma ignition device according to claim 3, wherein a diameter of an opening of the protection layer reduces gradually toward a free end.

9. The plasma ignition device according to claim 1, wherein an inner diameter of the insulation member and a diameter of an opening of the ground electrode increase gradually so that a diameter of the discharge space may increase toward a free end.

10. The plasma ignition device according to claim 1, further comprising:
a semiconductor section that is formed at a part of a surface of the insulation member, faces the discharge space, and abuts the ground electrode.

11. The plasma ignition device according to claim 1, wherein a diameter of a ground electrode opening increases at a wider angle so as to be larger than an inner diameter of the insulation member.

12. The plasma ignition device according to claim 1, wherein the ground electrode has a plurality of protrusions extending radially inward.
